(19) United States
(12) Patent Application Publication
(10) Pub. No.: US 2013/0050133 A1
(43) Pub. Date: Feb. 28, 2013

(54) METHOD AND APPARATUS FOR PRECLUDING OPERATIONS ASSOCIATED WITH ACCIDENTAL TOUCH INPUTS

(71) Applicants: Jörg Brakensiek, Mountain View, CA (US); Raja Bose, Mountain View, CA (US)

(72) Inventors: Jörg Brakensiek, Mountain View, CA (US); Raja Bose, Mountain View, CA (US)

(73) Assignee: NOKIA CORPORATION, Espoo (FI)

(21) Appl. No.: 13/221,344

(22) Filed: Aug. 30, 2011

(51) Int. Cl. G06F 3/044

(52) U.S. Cl. 345/174

(57) ABSTRACT

An apparatus, method, and computer program product are described that provide for a determination of the validity of an input based, at least in part, on a force indication relating to the input received and a proximity indication. An operation associated with the input may be precluded (e.g., the input may be disregarded) based, at least in part, on a determination that the input is invalid. When the input is determined to be valid, on the other hand, the associated operation may be executed. As a result, the execution of operations that are unintended (such as operations that are associated with accidental contact with the touch screen display) may be minimized, and the user's experience with the device can be enhanced.

### TECHNOLOGICAL FIELD

Embodiments of the present invention relate generally to precluding operations associated with accidental touch inputs. In particular, embodiments of the present invention relate to an apparatus and method for determining the validity of an input to a touch screen display based, at least in part, on a proximity indication and a force indication and precluding an operation associated with the input based on a determination of invalidity.

### BACKGROUND

Touch screen displays are becoming more prevalent in society. Various types of devices, from cash registers for facilitating retail transactions to cellular telephones and other personal mobile devices, feature touch screen displays as an interface for receiving input from users.

Although touch screen displays are a convenient way to receive purposeful inputs from users, they are also prone to registering and executing operations as a result of accidental touch inputs.

Accordingly, it may be desirable to provide an improved mechanism for receiving inputs on a touch screen display and disregarding accidental inputs from the user, but executing operations associated with valid inputs.

### BRIEF SUMMARY OF EXAMPLE EMBODIMENTS

Accordingly, embodiments of an apparatus, method, and computer program product are described that determine the validity of an input and preclude an operation associated with an invalid input. Embodiments of an apparatus for providing for the preclusion of an operation associated with an invalid input may include at least one processor and at least one memory including computer program code. The at least one memory and the computer program code may be configured to, with the processor, cause the apparatus to receive an input via a touch screen display, receive a force indication relating to the input received, and receive a proximity indication in response to receiving the input. The apparatus may further be caused to determine a validity of the input based, at least in part, on the proximity indication and the force indication and to provide for preclusion of an operation associated with the input based, at least in part, on a determination that the input is invalid.

In some cases, the memory and computer program code may be configured to, with the processor, cause the apparatus to determine the validity of the input based, at least in part, on a comparison of the force indication with a threshold force value. The threshold force value may be based, at least in part, on the proximity indication. Furthermore, the memory and computer program code may be configured to, with the processor, cause the apparatus to determine the validity of the input based, at least in part, on a comparison of the proximity indication with a threshold proximity value.

In some embodiments, the memory and computer program code may be configured to, with the processor, cause the apparatus to provide for execution of the operation associated with the input based, at least in part, on a determination that the input is valid. The operation may be associated with a force input, and the memory and computer program code may be further configured to, with the processor, cause the apparatus to provide for the execution of the operation based, at least in part, on the force indication. In some cases, the memory and computer program code may be further configured to, with the processor, cause the apparatus to receive a position indication relating to the input received and to provide for execution of the operation associated with the input based, at least in part, on the position indication.

In other embodiments, a method and a computer program product are provided for precluding an operation associated with an invalid input. The method may include receiving an input via a touch screen display of an apparatus, receiving a force indication relating to the input received, and receiving a proximity indication in response to receiving the input. A validity of the input may be determined based, at least in part, on the proximity indication and the force indication, and the preclusion of an operation associated with the input may be provided for based, at least in part, on a determination that the input is invalid.

In some cases, the validity of the input may be determined by, among other things, comparing the force indication with a threshold force value. The threshold force value may be based, at least in part, on the proximity indication, and the proximity indication may be compared with a threshold proximity value.

Embodiments of the method may further include providing for execution of the operation associated with the input based, at least in part, on a determination that the input is valid. For example, in some embodiments the operation may be associated with a force input, and providing for the execution of the operation may include providing for the execution of the operation based, at least in part, on the force indication. Additionally or alternatively, the method may include receiving a position indication relating to the input received and providing for execution of the operation associated with the input based, at least in part, on the position indication.

In still other embodiments, an apparatus is provided for precluding an operation associated with an invalid input that includes means for receiving an input via a touch screen display of an apparatus, means for receiving a force indication relating to the input received, and means for receiving a proximity indication in response to receiving the input. The apparatus may further comprise means for determining a validity of the input based, at least in part, on the proximity indication and the force indication, and means for providing for the preclusion of an operation associated with the input based, at least in part, on a determination that the input is invalid.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for precluding operations associated with invalid inputs according to an example embodiment of the present invention;

FIG. 3 illustrates an apparatus configured to preclude operations associated with invalid inputs according to an example embodiment of the present invention;

FIG. 4 shows the apparatus of FIG. 3 with a portion of the touch screen display removed to show force sensors in accordance with an example embodiment of the present invention;

FIG. 5 illustrates a look-up table relating proximity indications with threshold force values according to an example embodiment of the present invention;

FIG. 6 shows an apparatus according to an example embodiment of the present invention, in which the touch screen display is displaying a force-sensitive user interface element and a non-force-sensitive user interface element;

FIG. 7 illustrates an apparatus according to an example embodiment of the present invention, in which a first position indication and a second position indication are received; and

FIGS. 8-10 illustrate flowcharts of methods of precluding operations associated with invalid inputs in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Some devices, such as mobile terminals, include touch screen displays (e.g., capacitive touch screens) that are configured to receive inputs from users in the form of touch events. Although the use of touch screen displays facilitates the receipt of user inputs and may make user interaction with the device more intuitive and less complicated, any contact with the touch screen display may be interpreted by the device as an input, whether the contact was intentional or accidental. For example, in the case of a cellular telephone with a touch screen display, contact between a user's cheek and the touch screen display while the user is talking on the phone may serve as an input to the device, resulting in the execution of unintended operations (such as, e.g., placing the call on speakerphone, muting the call, or ending the call prematurely).

In devices that use projected capacitive touch sensors for the touch screen display, this problem may be compounded, as actual contact may not be required for a touch event. Rather, in such devices, the proximity of any conductive object, such as a finger, hand, ear, or cheek, to the sensor glass of the touch screen display may be registered as a touch event.

Accordingly, embodiments of the apparatus, method, and computer program product described below provide for a determination of the validity of an input based, at least in part, on a force indication relating to the input received and a proximity indication. An operation associated with the input may be precluded based, at least in part, on a determination that the input is invalid, as described in greater detail below. In other words, an operation that is associated with an input that has been determined to be invalid, based on the force indication and/or the proximity indication, may be disregarded (e.g., the operation may not be executed). An input that is determined to be valid, on the other hand, may result in the execution of the operation associated with the input. As a result, the execution of unintended operations (such as operations associated with accidental contact with the touch screen display) may be minimized, and the user's experience with the device can be enhanced.

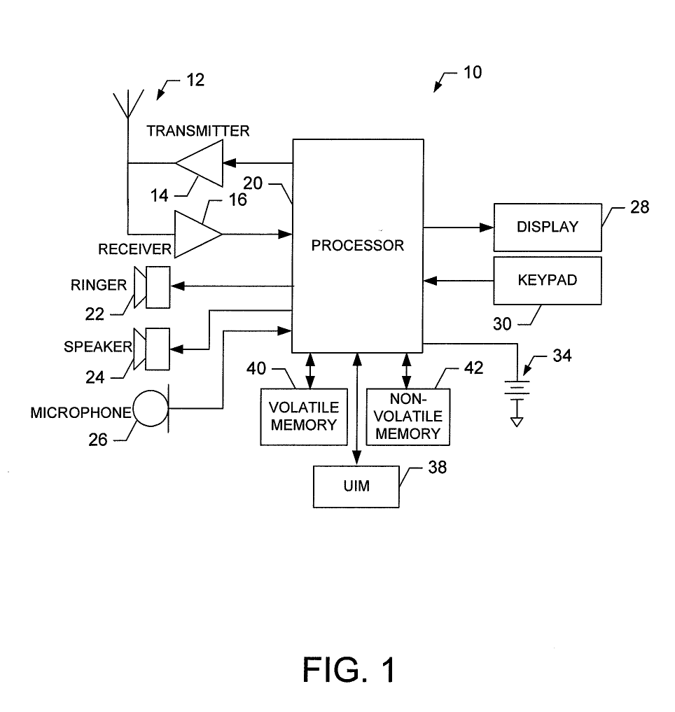

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

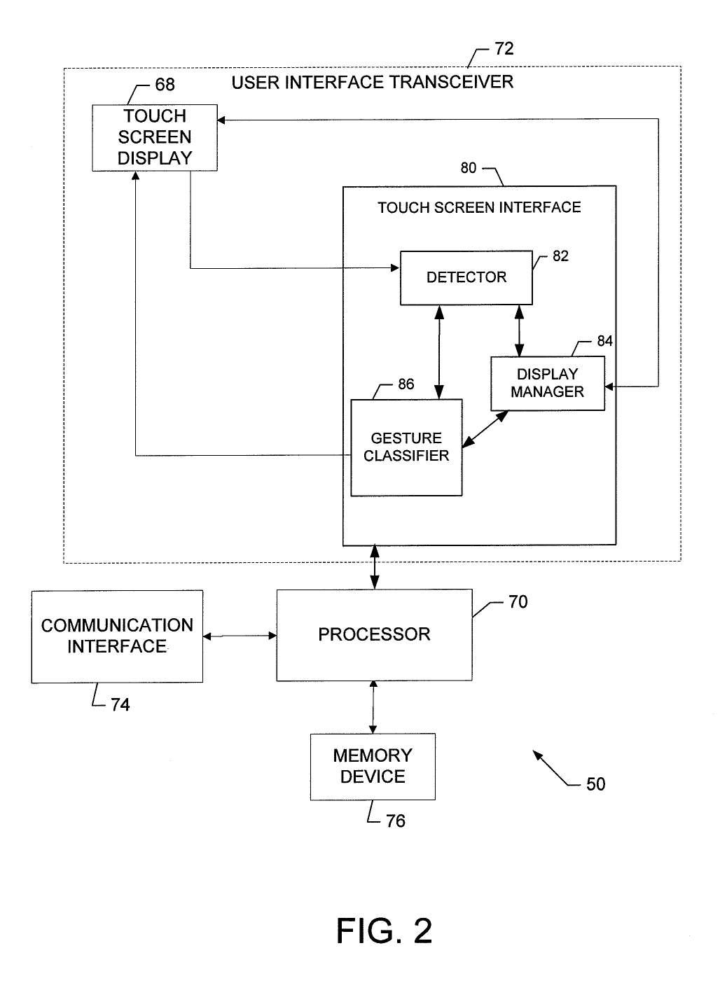

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, in which certain elements of an apparatus 50 for determining the validity of an input and precluding an operation associated with an invalid input are depicted. The apparatus 50 of FIG. 2 may be employed, for example, in conjunction with the mobile terminal 10 of FIG. 1. However, it should be noted that the apparatus 50 of FIG. 2 may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for determining the validity of an input and precluding an operation associated with an invalid input, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for determining the validity of an input and precluding an operation associated with an invalid input may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive indications of user inputs at the touch screen display 68 and to modify a response to such indications based on corresponding user actions that may be inferred or otherwise determined responsive to the indications.

In this regard, various indications of user input may be received as a result of touch events at the touch screen display 68. For example, a force indication may be received, which is indicative of the amount of force applied due to contact with the touch screen display 68. Alternatively or additionally, a position indication may be received (e.g., x-, y-coordinates) that describes the location of the contact. As another example, a proximity indication may be received in some cases that is indicative of the proximity of an object (such as the user's finger, the user's cheek, a wallet, or some other object) to the touch screen display 68.

Although the indications may be received due to contact with or proximity to the touch screen display, the indications may or may not be related to a purposeful (e.g., a valid) input. For example, a proximity indication that indicates the proximity of an object to the touch screen display may in one instance be related to a valid input by the user, such as when the user is contacting a portion of the touch screen display to execute a particular operation (e.g., to view an e-mail); however, in another instance, a proximity indication indicating the proximity of an object to the touch screen display may be related to an invalid input, such as when the user's cheek makes incidental contact with a region of the touch screen display, for example, while taking a phone call.

With continued reference to FIG. 2, in an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, a display manager 84, and a gesture classifier 86. Each of the detector 82, the display manager 84, and the gesture classifier 86 may be any device or means embodied in either hardware or a combination of hardware and software configured to perform the corresponding functions associated with the detector 82, the display manager 84, and the gesture classifier 86, respectively, as described herein. In an exemplary embodiment, each of the detector 82, the display manager 84, and the gesture classifier 86 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device or object, coming into contact with a portion of the touch screen display in a manner sufficient to register as a touch. In this regard, for example, a touch event could be a detection of pressure on the screen of the touch screen display 68 above a particular pressure threshold over a given area. Subsequent to each touch event, the detector 82 may be further configured to pass along the data corresponding to the touch event (e.g., location of touch, length of touch, number of objects touching, touch pressure, speed of movement, direction of movement, length of delay, frequency of touch, etc.) to the gesture classifier 86 for gesture classification. As such, the detector 82 may include or be in communication with one or more force sensors configured to measure the amount of touch pressure (e.g., force over a given area) applied as a result of a touch event, as an example.

The gesture classifier 86 may be configured to recognize and/or determine a corresponding classification of a touch event. In other words, the gesture classifier 86 may be configured to perform gesture classification to classify the touch event as any of a number of possible gestures. Some examples of recognizable gestures may include a touch, multi-touch, stroke, character, symbol, shape, swipe, pinch event (e.g., a pinch in or pinch out), and/or the like.

A touch may be defined as a touch event that impacts a single area (without or with minimal movement on the surface of the touch screen display 68) and then is removed. A multi-touch may be defined as multiple touch events sensed concurrently (or nearly concurrently). A stroke event may be defined as a touch event followed immediately by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a drag operation or as a flick operation). Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart. After initial occurrence of the multi-touch event involving at least two objects, one or more of the objects may move substantially toward each other to simulate a pinch. Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other.

The gesture classifier 86 may also be configured to communicate detection information regarding the recognition, detection, and/or classification of a touch event to the display manager 84. The display manager 84 may be configured to provide control over modifications made to that which is displayed on the touch screen display 68 based on the detection information received from the detector 82 and gesture classifications provided by the gesture classifier 86 in accordance with the responses prescribed for each respective gesture classification and implementation characteristic determined by the gesture classifier 86. In other words, the display manager 84 may configure the display (e.g., with respect to the content displayed and/or the user interface effects presented relative to the content displayed) according to the gesture classification and implementation characteristic classification determined for a given touch event that may be detected at the display.

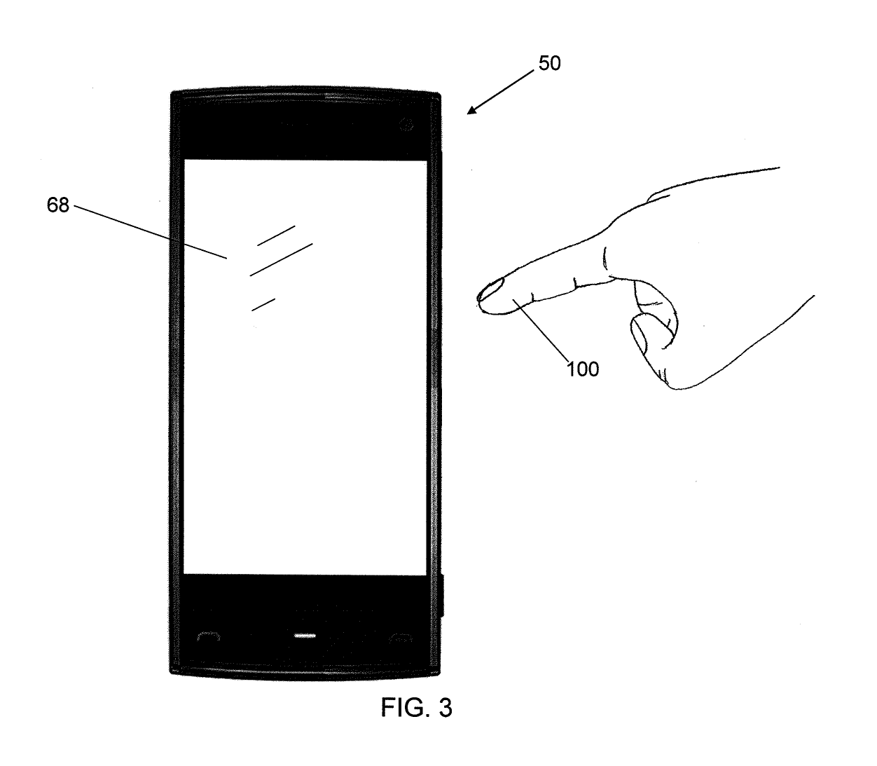

Turning now to FIG. 3, in general, an apparatus 50, such as the mobile terminal 10 of FIG. 1, is provided that has a touch screen display 68. As described above, the apparatus 50 may comprise at least one processor (e.g., processor 70 of FIG. 2) and at least one memory (e.g., memory device 76 of FIG. 2) including computer program code. The at least one memory and the computer program code may be configured to, with the processor, cause the apparatus 50 to at least receive an input (e.g., in the form of a touch event) via the touch screen display 68 of the apparatus. For example, a user may touch the touch screen display 68 with a finger 100 as part of a gesture to provide the input. As another example, the input may be provided through the user's accidental contact with the touch screen display 68 (e.g., the user's cheek may brush the display).

As noted above, various indications may be received (e.g., by the user interface transceiver 72 of FIG. 2) as a result of contact with the touch screen display 68, and the indication may describe one or more components of the input or the environment in which the input was received. For example, the at least one memory and the computer program code may be configured to, with the processor, cause the apparatus to receive a force indication relating to the input received. In addition, the at least one memory and the computer program code may be configured to, with the processor, cause the apparatus to receive a proximity indication in response to receiving the input. In this regard, the proximity indication may be related to the input received (e.g., describing the proximity of the object contacting the touch screen display), or the proximity indication may be associated with some other object or objects in the vicinity of the touch screen display 68 at the time the input was received. For example, upon receiving the force indication, the processor may, e.g., query a proximity sensor, and the proximity sensor may detect the proximity of any object in the vicinity and provide a corresponding proximity indication in response to the query. As another example, the proximity of an object may be automatically detected at or about the same time that the input is received, and the proximity indication may be received along with the force indication.

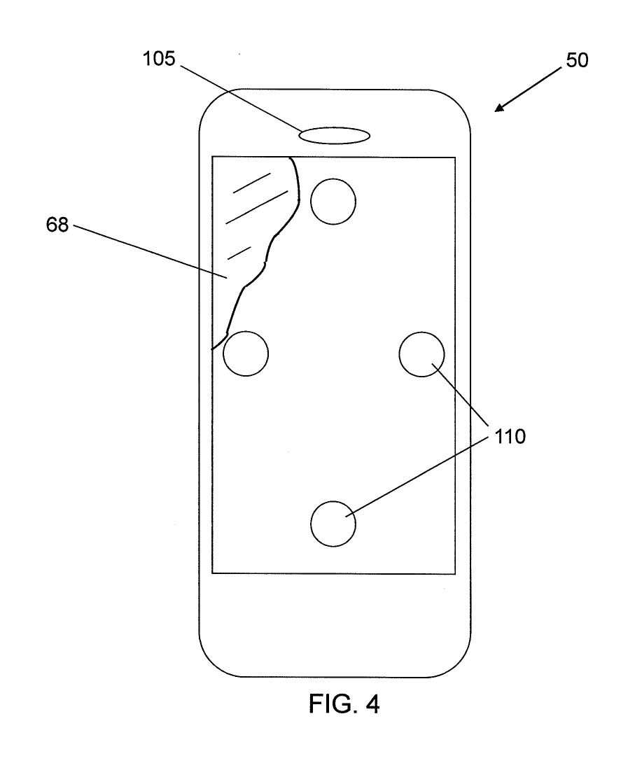

Thus, in some embodiments, one or more proximity sensors may be provided on or near the touch screen display 68 that are configured to detect the proximity of one or more objects to the touch screen display. For example, in FIG. 4, a proximity sensor 105 is provided near the touch screen display 68. The proximity sensor 105 may, in some cases, be a light sensor that detects the amount of light at the sensor. In this case, the detection of relatively high levels of light may result in the receipt of a proximity indication that is indicative of no objects being proximate the touch screen display 68 (e.g., because no objects, or no large objects, are blocking the ambient light from reaching the light sensor). In contrast, the detection relatively low levels of light may result in a proximity indication that is indicative of the proximity of one or more objects to the touch screen display 68. Other types of proximity sensors may include infra-red sensors, capacitive sensors, and other sensors that can detect whether objects are present within a certain distance from the touch screen display 68.

One or more force sensors 110 may also be provided beneath the touch screen display 68, as depicted in FIG. 4. The force sensors 110 may be configured to measure the force applied to the touch screen display as a result of the touch event. The apparatus 50 may in turn receive a force indication relating to the force of the input received. The force indication may, for example, be the measured force of the input (e.g., a magnitude of the force), or the force indication may be a binary indication identifying whether force exceeding a threshold level (or one of multiple threshold levels) was received. For example, a small amount of measured force that does not exceed a first threshold may be represented as first force indication (e.g., a “level 1” force); a larger amount of measured force exceeding the first threshold but less than a second threshold may be represented as a second force indication (e.g., a “level 2” force); an even larger amount of measured force exceeding the second threshold but less than a third threshold may be represented as a third force indication (e.g., a “level 3” force); and so on.

The apparatus 50 may thus be further configured to determine a validity of the input based, at least in part, on the proximity indication and the force indication. In some embodiments, for example, the at least one memory and the computer program code may be configured to, with the processor, cause the apparatus to determine the validity of the input based, at least in part, on a comparison of the force indication with a threshold force value. For example, in some cases, a force indication that exceeds a threshold force value may be indicative of an input that is the result of a purposeful contact with the touch screen display and that, as a result, includes some amount of force applied by the user to interact with the touch screen display.

In some cases, the threshold force value may be based, at least in part, on the proximity indication. For example, a proximity indication indicative of a large object near the touch screen display (e.g., the user's cheek) may result in a higher threshold force value. Thus, the force indication, in this example, would have to be higher (e.g., the force with which the input is applied to the touch screen display would have to be greater) to exceed the threshold force value and signal a valid input. In other words, due to the proximity of a large object to the touch screen display, the likelihood that the input was an accidental contact (e.g., incident to the nearness of a large object, such as the user's cheek) is greater, and so the input must be applied more purposefully (with greater force) to be seen as a valid input. On the other hand, when the proximity indication reflects the absence of objects proximate the touch screen display (e.g., the absence of a large object that may have caused an accidental input), the threshold force value may be set lower, such that a less forceful input may be seen as a valid input.

Accordingly, a relationship may exist between force and proximity (e.g., between the threshold force value and the proximity indication). The relationship may, in some cases, be governed by an algorithm that relates force and proximity For example, the force threshold value F_{T} and the proximity indication P may be related through the equation F_{T}=kP+F₀, where k is a constant, P is the proximity indication value, and F₀ is an offset force (which in some cases may be equal to 0). In this example, a higher proximity indication P may indicate a closer proximity of an object. In addition the force threshold value F_{T} may be a value selected from a range of values (e.g., between a maximum force threshold value Fₘₐₓ and a minimum force threshold value Fₘᵢₙ).

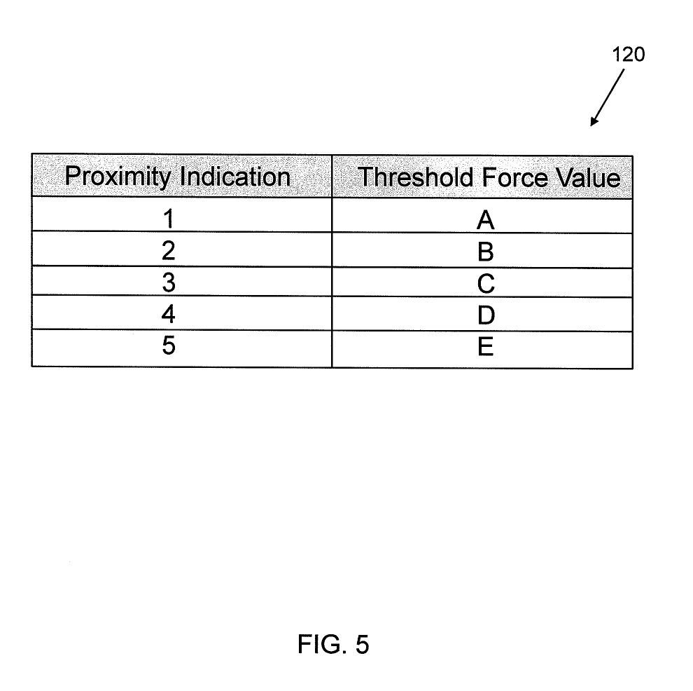

In other cases, a look-up table may be provided that includes predefined threshold force values for certain proximity indications. For example, FIG. 5 depicts a look-up table 120 in which the proximity indication has a numerical value between 1 and 5 and the corresponding threshold force value for each proximity indication is represented by a capital letter between A and E. Thus, in this example, a proximity value of 2 that is received would translate to a threshold force value of B. As a result, only inputs that have a corresponding force indication that exceeds B (in this example) would be determined to be valid inputs according to one embodiment.

The memory and computer program code may be configured to, with the processor, cause the apparatus to determine the validity of the input based, at least in part, on a comparison of the proximity indication with a threshold proximity value. For example, the determination may be made that the input is valid if the proximity indication is less than a threshold proximity value (which may reflect the absence of an object that may be likely to cause an accidental touch event). In some cases, a determination that the proximity indication is less than a threshold proximity value may trigger a comparison of the force indication with the threshold force value to see if the threshold force value is exceeded. Furthermore, in some cases, the force indication may be compared to the threshold force value as described above and, if the force indication exceeds the threshold force value, the proximity indication may be compared to a threshold proximity value. If the proximity indication in this case is less than the threshold proximity value, then the determination may be made that the input is a valid input. It is noted, however, that, depending on how the proximity indication is derived and what is described by the proximity indication (e.g., whether the proximity indication describes the presence of an object or the absence of an object in the vicinity of the touch screen display), the apparatus may in some cases be configured to determine that the input is invalid if the proximity indication is less than the proximity threshold value.

Regardless of how the determination of validity is made, the apparatus 50 may be configured to provide for preclusion of an operation associated with the input based, at least in part, on a determination that the input is invalid. In this way, an input that is determined to be the result of an accidental touch event (rather than purposeful contact between the user and the touch screen display 68) may be disregarded and would not result in the execution of any unintended operation. Furthermore, the memory and computer program code may be configured to, with the processor, cause the apparatus to provide for execution of the operation associated with the input based, at least in part, on a determination that the input is valid. Thus inputs that are determined to be valid (and, therefore, not the result of unintended touch events) would result in the execution of the operation and would not be ignored.

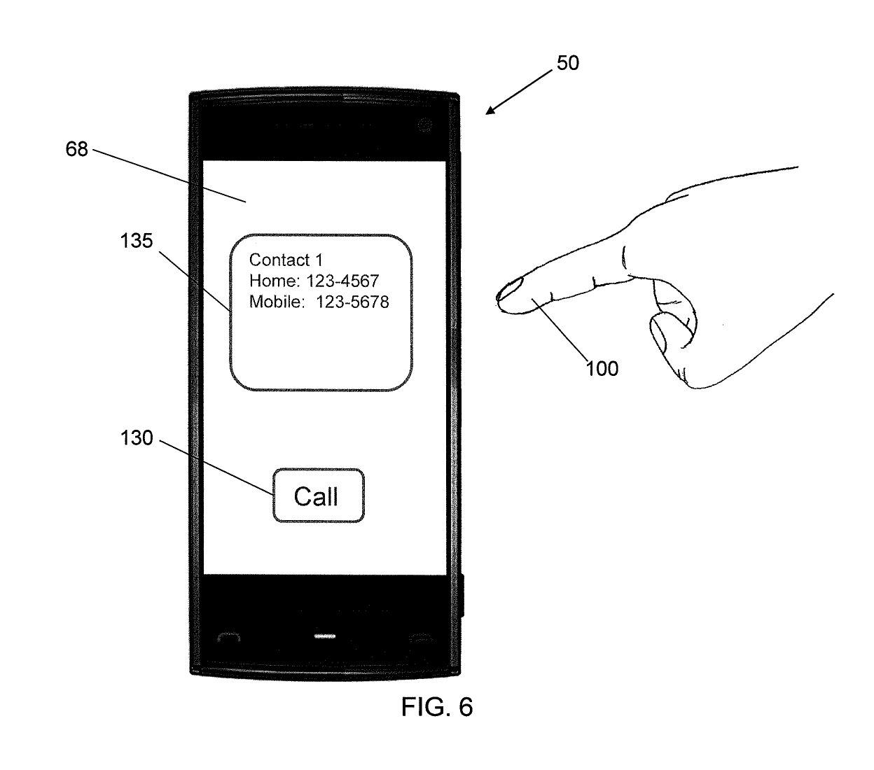

In some embodiments, the apparatus may be configured to provide for the execution of an operation based, at least in part, on the force indication. For example, user interface elements 130, 135 (e.g., buttons or interactive menus) may be displayed on the touch screen display 68, as shown in FIG. 6, for receiving inputs from users. Some of the user interface elements 130 (such as a “Call” button) may be associated with operations (initiating a call) that require a force indication to be received, whereas other user interface elements 135 (such as a Contact entry) may not. In this example, a user may swipe his finger across a portion of the touch screen display 68 that shows the information for Contact 1 to move between contacts (e.g., swiping to the left to move from Contact 1 to Contact 2 to Contact 3, etc.). The operation of moving between Contacts may not require that a force indication be received. Thus, relatively “light” swipe gestures (e.g., gestures that involve relatively little force applied to the touch screen display) may effect the change of the display of Contact information. The operation of initiating a call for the displayed Contact, however, may require that a force indication be received, so as to avoid placing a call as a result of an accidental touch event at the user interface element 130. Thus, the apparatus 50 would only provide for the execution of the operation (e.g., initiating a call to the displayed Contact) based, at least in part, on the force indication relating to the input received at the respective user interface element 130.

Accordingly, in some embodiments, the memory and computer program code may be further configured to, with the processor, cause the apparatus to receive a position indication relating to the input received and to provide for execution of the operation associated with the input based, at least in part, on the position indication. For example, the touch screen display 68 may be configured to detect the position of the input, e.g., by determining the x-, y-coordinates of the user's touch. This may be done using triangulation techniques. In this way, the apparatus may determine whether the position of the input (e.g., the x-, y-coordinates) is within the boundary of a force-sensitive user interface element 130 (a user interface element, as described above, that requires receipt of a force indication for the execution of the corresponding operation). If so, a force indication relating to the input may be received and considered for the execution of the associated operation.

For example, the apparatus (e.g., via the touch screen display) may detect the position of the input (e.g., the x-, y-coordinates), whereas one or more force sensors may measure the force exerted by the user's touch and a proximity sensor may determine a proximity indication (e.g., a light sensor may detect the light level incident on the touch screen display). Specific user interface elements may be designated as force-sensitive in this example. Thus, if an input (e.g., a touch) is detected by the apparatus, the apparatus may compare the proximity indication against a proximity threshold value (e.g., to see if the level of light incident on the display in this example is indicative of a valid input). If the proximity indication is indicative of a valid input, the apparatus may then determine whether the location of the input is within the bounding box of a force-sensitive user interface element. If it is not, then the input is considered a valid touch gesture. If the input is within the bounding box of a force-sensitive user interface element, then the force sensor may be queried for one or more force values of the input. If the force values exceed a threshold force value, then the input is a valid touch gesture. If the force values do not exceed a threshold force value, then the input is considered an invalid input.

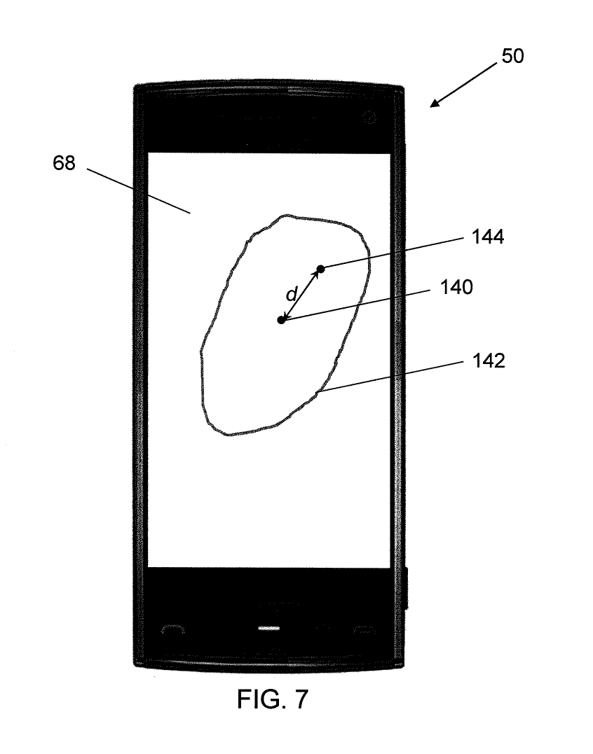

In some cases, more than one position indication may be received. For example, a first position indication (e.g., coordinates x, y) may be received as described above, which describes a location of the user's contact with the touch screen display 68. In addition, a second position indication (e.g., coordinates x1, y1) may be received, which describes a location of the force applied to the touch screen display 68. In embodiments in which multiple force sensors 110 are provided (as shown in FIG. 4), a location of the force may also be derived using the force sensors. For example, a force gradient may be detected across the touch screen display surface by the force sensors 110, and the gradient may be used to compute the coordinates of the point at which the force was applied, as well as the magnitude of the force. The first position indication may then be compared to the second position indication to determine whether the location of the force corresponds to the location of the contact with the touch screen display 68. If the locations do not correspond (e.g., if the distance between the coordinates d is not less than a predefined distance D), the input may be determined to be invalid. This may be the case when a large object, such as the user's cheek, contacts the touch screen display across a wide contact area 142 (which may provide as the first position indication 140 a center point of the contact area), while the force is applied by the user's cheekbone at a focused location 144 (from which the second position indication is derived) within the contact area, but not coinciding with the center point used as the first position indication. This scenario is illustrated in FIG. 7.

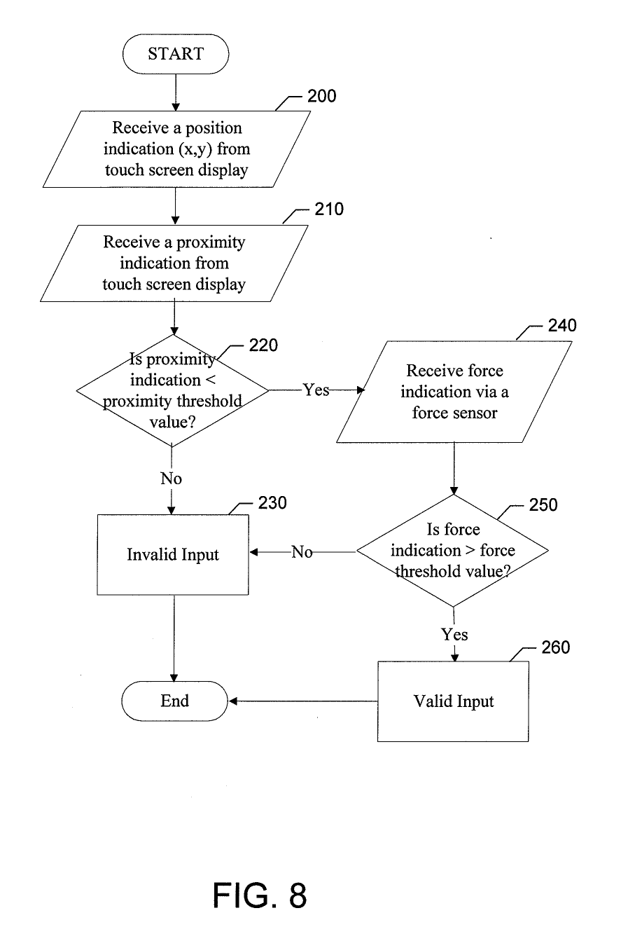

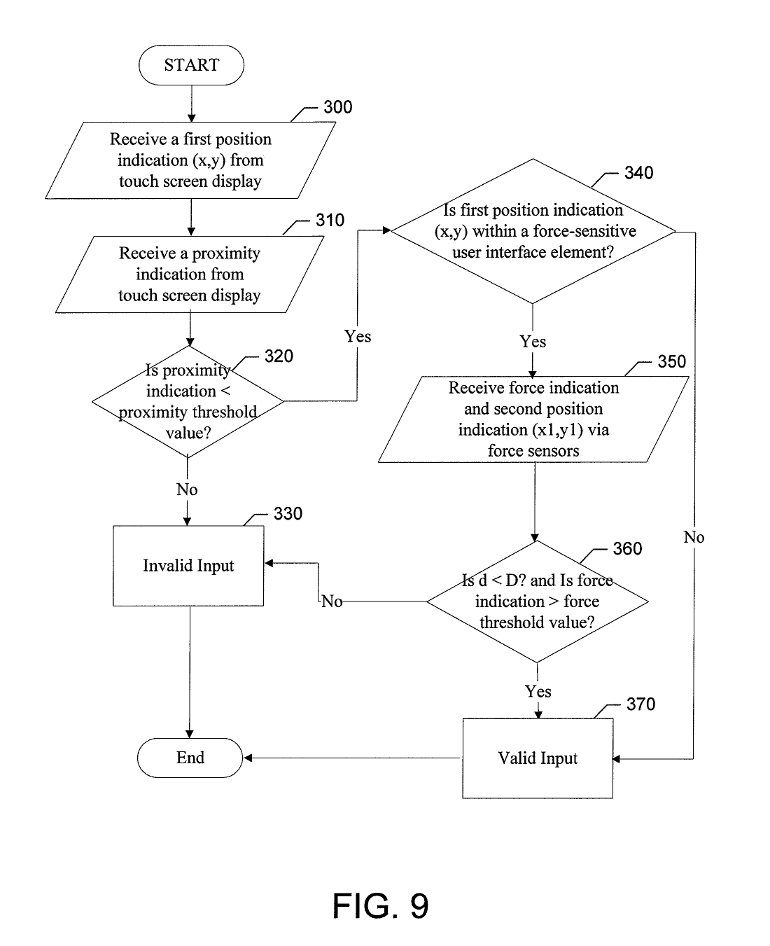

Examples of flowcharts depicting the logic that may be used (on a user interface level or an operating system level) to determine the validity of an input and provide for preclusion of an operation associated with an invalid input (and/or provide for execution of an operation associated with a valid input) is shown in FIG. 8 for an apparatus that includes a single force sensor and in FIG. 9 for an apparatus that includes multiple force sensors that are configured to provide a location of the applied force.

In FIG. 8, a position indication (x,y) is received from the touch screen display at operation 200. A proximity indication is received from the touch screen display at operation 210. At operation 220, the proximity indication is compared to the proximity threshold value to determine whether it is less than the proximity threshold value. If the proximity indication is not less than the proximity threshold value, then it is determined that the input is invalid at operation 230.

If the proximity indication is indeed less than the proximity threshold in the depicted example, then a force indication is received via a force sensor at operation 240. The force indication is then compared to a force threshold value at operation 250, and if the force indication is greater than the force threshold value, then the input is determined to be a valid input at operation 260. Otherwise, the input is considered an invalid input as operation 230.

Referring to FIG. 9, when multiple force sensors are involved, the apparatus may receive a first position indication (x,y) from the touch screen display at operation 300, as described above. The apparatus may also receive a proximity indication from the touch screen display at operation 310. The proximity indication may then be compared to a proximity threshold value at operation 320. If the proximity indication is not less than the proximity threshold value (in this example), then the input is determined to be invalid at operation 330. If the proximity indication is less than the proximity threshold value, then a determination is made at operation 340 as to whether the first position indication (x,y) is within a boundary of a force-sensitive user interface element.

If the first position indication (x,y) is within the bounds of a force-sensitive user interface element, then a force indication and a second position indication (x1,y1) is received via the force sensors at operation 350. The first position indication (x,y) and the second position indication (x1,y1) are then compared to determine whether the difference between the two locations d is less than an acceptable distance D at operation 360. The force indication is also compared to the force threshold value at operation 360. If the two position indications are within a tolerable distance from each other (e.g., d<D) and the force indication is greater than the force threshold value, then the determination is made at operation 370 that the input is valid. If the first position indication is not within an acceptable distance from the second position indication (as described above), or if the force indication is not greater than the force threshold value, then the input is invalid at operation 330.

If, however, at operation 340 the first position indication (x,y) is determined not to be within a force-sensitive user interface element (e.g., if the first position indication (x,y) falls outside the bounds of a force-sensitive user interface element, as described above), then the input is determined to be valid at operation 370 without regard to the second position indication or the force indication in this embodiment. Furthermore, in some cases, force sensitive user interface elements may designated to respond to different levels of force. For example, some user interface elements may not require any force to provide for the execution of a function (e.g., may not be force-sensitive), some user interface elements may require a low amount of force to provide for the execution of a function, and other user interface elements may require a higher amount of force to provide for the execution of a function.

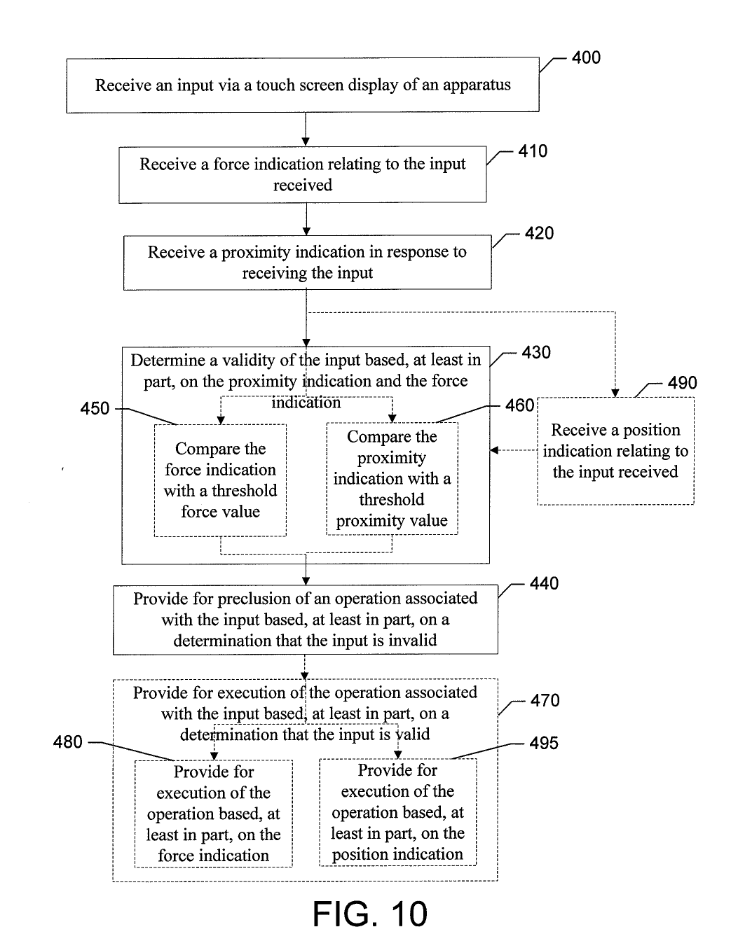

FIG. 10 illustrates a flowchart of a system, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method for determining the validity of an input and precluding an operation associated with an invalid input, as shown in FIG. 10, includes receiving an input via a touch screen display of an apparatus at operation 400, receiving a force indication relating to the input received at operation 410, and receiving a proximity indication in response to receiving the input at operation 420, as described above. A validity of the input may be determined based, at least in part, on the proximity indication and the force indication at operation 430, and an operation associated with the input may be precluded based, at least in part, on a determination that the input is invalid at operation 440.

In some cases, the validity of the input may be determined by comparing the force indication with a threshold force value (operation 450) and/or by comparing the proximity indication with a threshold proximity value (operation 460). In some embodiments, the threshold force value is based, at least in part, on the proximity indication.

Furthermore, the operation associated with the input may be executed based, at least in part, on a determination that the input is valid, as shown at operation 470. In some embodiments, where the operation is associated with a force input, the operation may be executed based, at least in part, on the force indication at operation 480.

A position indication relating to the input received may also be received in some cases, as described above and shown in operation 490. In such cases, the operation associated with the input may be executed, at least in part, on the position indication at operation 495.

In some embodiments, certain ones of the operations above may be modified or further amplified as described below. Furthermore, in some embodiments, additional optional operations may be included, some examples of which are shown in dashed lines in FIG. 10. Modifications, additions, or amplifications to the operations above may be performed in any order and in any combination.

In an example embodiment, an apparatus for performing the method of FIG. 10 above may comprise a processor (e.g., the processor 70 of FIG. 2) configured to perform some or each of the operations (400-495) described above. The processor may, for example, be configured to perform the operations (400-495) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operations 400-420 and 490 may comprise, for example, the user interface transceiver 72 and/or a device or circuit for executing instructions or executing an algorithm for processing information as described above. Examples of means for performing operations 430, 450, and 460 may comprise, for example, the processor 70, the memory device 76, and/or a device or circuit for executing instructions or executing an algorithm for processing information as described above. Examples of means for performing operation 440 may comprise, for example, the processor 70 and/or a device or circuit for executing instructions or executing an algorithm for processing information as described above. Moreover, examples of means for performing at least portions of operations 470, 480, and 495 may comprise, for example, the processor 70, the user interface transceiver 72, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
receive an input via a touch screen display;
receive a force indication relating to the input received;
receive a proximity indication in response to receiving the input;
determine a validity of the input based, at least in part, on the proximity indication and the force indication; and
provide for preclusion of an operation associated with the input based, at least in part, on a determination that the input is invalid.

2. The apparatus of claim 1, wherein the memory and computer program code are configured to, with the processor, cause the apparatus to determine the validity of the input based, at least in part, on a comparison of the force indication with a threshold force value.

3. The apparatus of claim 2, wherein the threshold force value is based, at least in part, on the proximity indication.

4. The apparatus of claim 1, wherein the memory and computer program code are configured to, with the processor, cause the apparatus to determine the validity of the input based, at least in part, on a comparison of the proximity indication with a threshold proximity value.

5. The apparatus of claim 1, wherein the memory and computer program code are configured to, with the processor, cause the apparatus to provide for execution of the operation associated with the input based, at least in part, on a determination that the input is valid.

6. The apparatus of claim 5, wherein the operation is associated with a force input, and wherein the memory and computer program code are further configured to, with the processor, cause the apparatus to provide for the execution of the operation based, at least in part, on the force indication.

7. The apparatus of claim 5, wherein the memory and computer program code are further configured to, with the processor, cause the apparatus to receive a position indication relating to the input received and to provide for execution of the operation associated with the input based, at least in part, on the position indication.

8. A method comprising:
receiving an input via a touch screen display of an apparatus;
receiving a force indication relating to the input received;
receiving a proximity indication in response to receiving the input;
determining a validity of the input based, at least in part, on the proximity indication and the force indication; and
providing for preclusion of an operation associated with the input based, at least in part, on a determination that the input is invalid.

9. The method of claim 8, wherein determining the validity of the input comprises comparing the force indication with a threshold force value.

10. The method of claim 9, wherein the threshold force value is based, at least in part, on the proximity indication.

11. The method of claim 8, wherein determining the validity of the input comprises comparing the proximity indication with a threshold proximity value.

12. The method of claim 8 further comprising providing for execution of the operation associated with the input based, at least in part, on a determination that the input is valid.

13. The method of claim 12, wherein the operation is associated with a force input, and wherein providing for the execution of the operation comprises providing for the execution of the operation based, at least in part, on the force indication.

14. The method of claim 12 further comprising receiving a position indication relating to the input received and providing for execution of the operation associated with the input based, at least in part, on the position indication.

15. A computer program product comprising at least one computer-readable storage medium having computer-executable program code portions stored therein, the computer-executable program code portions comprising program code instructions for:
receiving an input via a touch screen display of an apparatus;
receiving a force indication relating to the input received;
receiving a proximity indication in response to receiving the input;
determining a validity of the input based, at least in part, on the proximity indication and the force indication; and
providing for preclusion of an operation associated with the input based, at least in part, on a determination that the input is invalid.

16. The computer program product of claim 15, wherein determining the validity of the input comprises comparing the force indication with a threshold force value.

17. The computer program product of claim 16, wherein the threshold force value is based, at least in part, on the proximity indication.

18. The computer program product of claim 15, wherein determining the validity of the input comprises comparing the proximity indication with a threshold proximity value.

19. The computer program product of claim 15, wherein providing for execution of an operation associated with the input is based, at least in part, on a determination that the input is valid.

20. The computer program product of claim 19, wherein the operation is associated with a force input, and wherein providing for the execution of the operation comprises providing for the execution of the operation based, at least in part, on the force indication.

21. The computer program product of claim 19 further comprising program code instructions for receiving a position indication relating to the input received and providing for execution of the operation associated with the input based, at least in part, on the position indication.
